(19) United States
(12) Patent Application Publication
(10) Pub. No.: US 2026/0087749 A1
(43) Pub. Date: Mar. 26, 2026

(54) CUSTOM VIRTUAL-REALITY SPACE OF SUB-WORLDS EXTRACTED FROM EXISTING VIRTUAL WORLDS

(71) Applicant: INTERNATIONAL BUSINESS MACHINES CORPORATION, ARMONK, NY (US)

(72) Inventors: Timothy Waileong Koh, Chuo-ku (JP); KENYA ISHIMOTO, Machida-shi (JP); SHO AYUBA, Tokyo (JP); YOSHIO HORIUCHI, Hiratsuka-shi (JP)

(21) Appl. No.: 18/893,004

(22) Filed: Sep. 23, 2024

(51) Int. Cl. G06T 19/00; G06T 15/20

(52) U.S. Cl. CPC G06T 19/006; G06T 15/20

(57) ABSTRACT

According to one embodiment, a method, computer system, and computer program product for aggregating multiple virtual worlds is provided. The present invention may include receiving, from a world mapping tool, a plurality of world mappings pertaining to one or more virtual worlds; extracting multiple sub-worlds from the one or more virtual worlds based on the plurality of world mappings; creating an aggregate world comprising the multiple sub-worlds; transmitting a rendered view of the aggregate world to a user device for display to the user; determining an active world and one or more inactive worlds based on the world mappings and a location of a user avatar within the aggregate world; managing an active avatar within the active world corresponding to the user avatar within the aggregate world; and managing one or more proxy avatars within the one or more inactive worlds corresponding to the user avatar within the aggregate world.

### BACKGROUND

The present invention relates, generally, to the field of computing, and more particularly to virtual worlds.

Virtual worlds, or virtual spaces, may be computer-simulated virtual environments which may simulate real-world spaces, fantasy settings, or some combination of real-world spaces and fantastic elements. Virtual worlds may be populated by many simultaneous users who are each represented within the virtual world as an avatar; users may independently explore and interact, participate in virtual activities, and communicate with others within the virtual world through the avatar. The field of virtual worlds may be the technical field concerned with the hardware and software infrastructure that simulates virtual worlds, facilitates the networking necessary to support remotely controlled avatars within a virtual world, controls updates to the virtual world, et cetera.

### SUMMARY

According to one embodiment, a method, computer system, and computer program product for aggregating multiple virtual worlds is provided. The present invention may include receiving, from a world mapping tool, a plurality of world mappings pertaining to one or more virtual worlds; extracting multiple sub-worlds from the one or more virtual worlds based on the plurality of world mappings; creating an aggregate world comprising the multiple sub-worlds; transmitting a rendered view of the aggregate world to a user device for display to the user; determining an active world and one or more inactive worlds based on the world mappings and a location of a user avatar within the aggregate world; managing an active avatar within the active world corresponding to the user avatar within the aggregate world; and managing one or more proxy avatars within the one or more inactive worlds corresponding to the user avatar within the aggregate world.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating an aggregate world process according to at least one embodiment;

FIG. 3 illustrates an exemplary world mapping process comprising the aggregate world process according to at least one embodiment;

FIG. 4 illustrates an exemplary avatar management process comprising the aggregate world process according to at least one embodiment; and

FIG. 5 is a component diagram illustrating an exemplary embodiment of a system implementing an aggregate world process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to virtual worlds. The following described exemplary embodiments provide a system, method, and program product to, among other things, extract portions of one or more virtual worlds, and combine the extracted portions, or sub-worlds, into a single aggregate virtual world.

As previously described, virtual worlds may be computer-simulated virtual environments which may comprise digital instantiations of three-dimensional space; these virtual environments may simulate real-world spaces, fantasy settings, or some combination of real-world spaces and fantastic elements. Virtual worlds may operate according to a consistent set of rules, or physics, which defines how virtual objects, avatars, virtual entities, et cetera interact with the environment of the virtual world and with each other. Virtual worlds may be persistent; a virtual world may continue to exist and evolve even when no users are logged into that virtual world, and changes made to the virtual world may be saved and maintained such that they may be observed by other users later. A virtual world may allow multiple users to inhabit the same virtual environment simultaneously through avatars, independently seeing and interacting with each other's avatars and the virtual environment. While the interaction between users may be done in real-time, time consistency is not always maintained in online virtual worlds. Virtual worlds may be used for gaming, social interaction, instruction, research, et cetera. Virtual worlds greatly facilitate interaction across time and geographic boundaries by allowing users to enter a virtual world from anywhere in the physical world and interact with any other user as if they were physically present with that user, even where the two users may be separated physically by vast distances. Due to the large and increasing engagement with virtual worlds, especially among young children, improvements to the field of virtual worlds stand to yield considerable advantages.

Currently, when a user wishes to access a particular virtual world, the user starts an application to access that world, and the user is restricted to joining only that virtual world; the user can only interact within that virtual world, and may find it inconvenient if the user has multiple tasks to perform in several different virtual worlds. In such scenarios, the user would have to start an application, perform the tasks and interactions that the user wants to get done in that world, leave that world, stop the application, start another application for another world, and repeat the process for each virtual world.

As such, it may be advantageous to, among other things, implement a system that creates a custom VR space that is made from subsets of virtual worlds, known as sub-worlds, that are extracted from existing virtual worlds. Such a system would enable a user to position the sub world within a custom virtual space. When the user walks into the space of the sub-world via a user avatar, their user avatar would automatically adjust to that world's avatar and the user can interact with that world and participants within it, allowing the user to seamlessly transition between multiple virtual worlds.

Therefore, the present embodiment has the capacity to improve the technical field of virtual worlds by providing a system that aggregates important sub-regions of virtual worlds designated by the user into one single world and one single session, allowing the user to quickly and conveniently transition between virtual worlds without requiring the opening and closing of programs to visit virtual worlds one by one. This stands to combine multiple virtual worlds into one, improving efficiency, improving the user experience, and providing a new and useful capability that was not heretofore present in the art.

According to one or more embodiments, the invention is a method of extracting multiple sub-worlds from one or more virtual worlds, and combining the extracted sub-worlds into an aggregate world where a user may freely traverse between sub-worlds via a user avatar. In embodiments, the invention may be a method of adding additional sub-worlds to the aggregate world.

According to one or more embodiments, the invention is a method of identifying an active world and one or more inactive worlds of the one or more virtual worlds based on the user avatar's presence in or absence from a sub-world associated with a virtual world; continuously managing an active avatar in the active world; and continuously managing one or more proxy avatars in the one or more inactive worlds.

References in the specification to “one embodiment,” “other embodiment,” “another embodiment,” “an embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to affect such feature, structure, or characteristic in connection with other embodiments whether or not explicitly described.

For purposes of the description hereinafter, the terms “upper”, “lower”, “right”, “left”, “vertical”, “horizontal”, “top”, “bottom”, and derivatives thereof shall relate to the disclosed structures and methods, as oriented in the drawing figures. The terms “overlying,” “atop,” “over,” “on,” “positioned on” or “positioned atop” mean that a first element is present on a second element wherein intervening elements, such as an interface structure, may be present between the first element and the second element. The term “direct contact” means that a first element and a second element are connected without any intermediary conducting, insulating, or semiconductor layers at the interface of the two elements.

In the interest of not obscuring the presentation of the embodiments of the present invention, in the following detailed description, some of the processing steps, materials, or operations that are known in the art may have been combined together for presentation and for illustration purposes and in some instances may not have been described in detail. Additionally, for brevity and maintaining a focus on distinctive features of elements of the present invention, description of previously discussed materials, processes, and structures may not be repeated with regard to subsequent Figures. In other instances, some processing steps or operations that are known may not be described. It should be understood that the following description is rather focused on the distinctive features or elements of the various embodiments of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to extract portions of one or more virtual worlds, and combine the extracted portions, or sub-worlds, into a single aggregate virtual world.

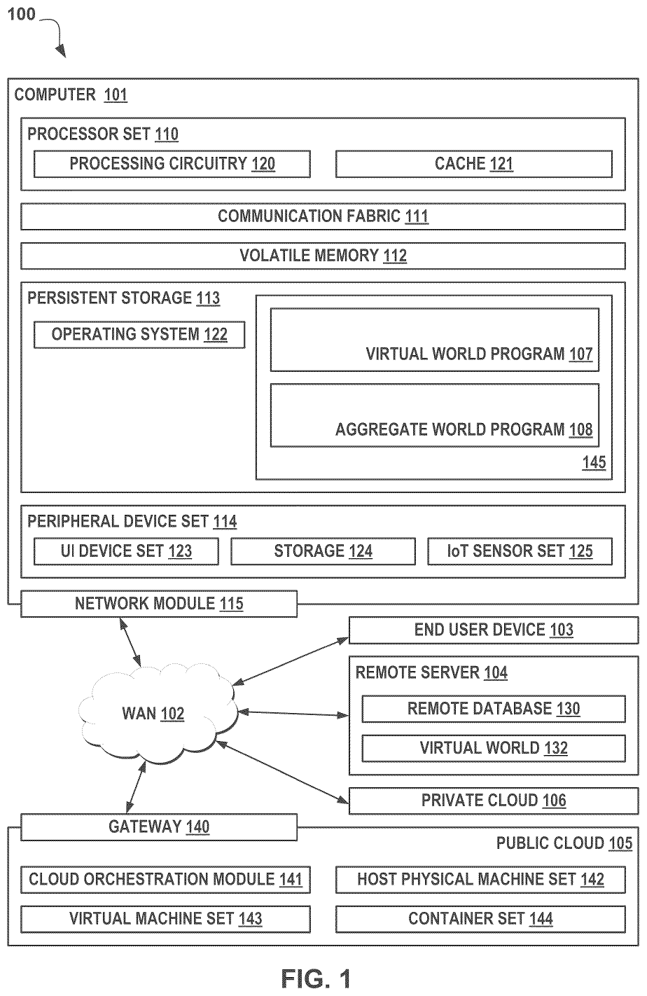

Referring now to FIG. 1, computing environment 100 contains an example of an environment for the execution of at least some of the computer code involved in performing the inventive methods, such as code block 145, which may comprise virtual world program 107 and aggregate world program 108. In addition to code block 145, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 145, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 145 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 145 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, haptic devices, and/or mixed reality devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the virtual world 132 may be an active computer simulation of a real-world space. The virtual world 132 may be capable of hosting multiple human users, allowing them to simultaneously inhabit the same virtual environment. The virtual world 132 may present perceptual stimuli to users and enable users to manipulate and/or otherwise interact with elements of the virtual world 132 to allow users to experience a degree of presence. The virtual world 132 may continuously update to model any changes made to the virtual world 132, such as by users or administrators, such that changes may be observed and/or experienced by other users after the change has been made. The virtual world 132 may be persistent, and may continuously save the state of the virtual world (e.g., user progress, environmental changes); this allows the virtual world 132 to maintain continuity even after users disconnect and reconnect. In embodiments, the virtual world 132 may continue to change and evolve even when no users are present, as the virtual world 132 may continue to model ongoing processes, and/or behaviors of non-player entities, that may continue to affect the virtual world 132 even in the absence of human users.

The virtual world 132 may exist and operate according to a consistent set of rules, or physics, that govern all aspects of the virtual world 132, such as, for example, spatial relationships between places and objects, topography, gravity, weather, lighting, movement and behaviors of avatars, objects and entities, communication between players, and the types and nature of interactions available to users. The physics of the virtual world 132 may draw from reality and/or fantasy worlds. Each virtual world 132 may be subject to its own separate and unique physics; in embodiments, for example where a virtual world 132 comprises multiple virtual environments, each virtual environment may be governed by partially or completely different physics.

The virtual world 132 may depict virtual environments drawn from a wide range of visual themes, including those based on the real world, science fiction, superheroes, sports, historical, and horror milieus. The virtual world 132 may be used for gaming, social interaction, instruction, research, et cetera. For example, the virtual world 132 may be a survival-crafting game depicting a vibrant, blocky fantasy world, may be a virtual reality educational experience modeling a range of tools and equipment within a realistic industrial environment, may be a massively multiplayer online game depicting a neon science-fiction inspired world, et cetera. In embodiments, the virtual world 132 may comprise a mirror world, which may be a representation of the real world in a digital form, similar to a digital twin, that attempts to map real-world structures into a virtual environment in a geographically accurate way.

The virtual world 132 may comprise a single virtual environment; the virtual environment may be a single geographically contiguous virtual area, where all users can see and interact with each other's avatars and can freely travel to any location within the virtual environment without requiring a break in the user experience to load a new virtual environment or a chunk of the virtual environment to be loaded from memory. The virtual environment may have a single consistent visual theme or may have multiple visual themes. In embodiments, the virtual world 132 may comprise multiple virtual environments; the virtual environments may be separate virtual areas, which may be geographically or mechanically connected to each other such that a user may travel from one virtual environment to another, for example at specific geographical points within a virtual area or by selecting a “fast travel” menu option. In embodiments, the virtual world 132 may comprise multiple instances of a virtual environment, where each instance comprises a copy of the virtual environment. The instances may be linked such that changes made by a user to any one instance are propagated to all instances, or may be self-contained, such that changes are only recorded within the instance where they occurred; in such embodiments, the instances may initially be identical when first instantiated but may diverge from each other as changes are made over time.

In embodiments, the virtual world 132 may be a mixed-reality virtual world; mixed reality represents the technology of merging real and virtual worlds such that physical and digital objects co-exist and interact in real time. Mixed reality does not exclusively take place in either the physical or virtual worlds, but is a hybrid of reality and virtual reality; as such, mixed reality describes everything in the reality-virtuality continuum except for the two extremes, namely purely physical environments, and purely virtual environments. Accordingly, mixed reality includes augmented reality (AR) and virtual reality (VR). Augmented reality is a modern computing technology that uses software to generate images, sounds, haptic feedback, and other sensations which are integrated into a real-world environment to create a hybrid augmented reality environment, comprising both virtual and real-world elements. Virtual reality is a modern computing technology that creates a virtual environment that fully replaces the physical environment, such that a user experiencing a virtual reality environment cannot see any objects or elements of the physical world; however, the virtual reality environment is anchored to real-world locations, such that the movement of participants, virtual objects, virtual environmental effects and elements all occur relative to corresponding locations in the physical environment. Augmented reality is distinct from virtual reality in that an augmented reality environment augments the physical environment by overlaying virtual elements onto the physical environment, whereas a virtual reality environment fully replaces the physical environment with a virtual environment to completely immerse the user in a computer-generated world. In other words, a user within a virtual reality environment cannot see any real-world objects or environments, while a user within an augmented reality environment can see both the physical environment and virtual elements. However, the virtual reality environments are anchored to real-world locations, such that the movement of users, virtual objects, virtual environmental effects, and elements all occur relative to corresponding locations in the physical environment.

In embodiments where the virtual world 132 comprises mixed reality, participants may interface with the mixed reality virtual world 132 via a user interface device that comprises a mixed reality device: The mixed reality device may be any device or combination of devices enabled to record real-world information that the virtual world program 107 may overlay with computer-generated perceptual elements to create the mixed-reality virtual world 132; the mixed reality device may further record the actions, position, movements, et cetera of the user, to track the user's movement within and interactions with the mixed reality virtual world 132. The mixed reality device may display the mixed reality virtual world 132 to the user. The mixed reality device may be equipped with or comprise a number of sensors such as a camera, microphone, accelerometer, et cetera, and these sensors and/or may be equipped with or comprise a number of user interface devices such as displays, touchscreens, speakers, et cetera. In some embodiments, the mixed reality device may be a headset that is worn by the participant.

Participants may interact with the virtual world 132 through an avatar: the avatar may be a digital construct representing individual participants within the virtual world 132. The avatar may be a visual representation of the user in the virtual world 132 that the user can control and move. The avatar may range in graphical sophistication from two-dimensional icons or profile pictures to fully realized and animated three-dimensional models. In embodiments, the participant may “see” through the eyes of the avatar, and be constrained to the capabilities and limitations of the avatar with respect to moving and interacting with the virtual world 132. The avatar may thereby represent a surrogate for the participant, allowing the participant to experience and become immersed in the virtual world 132 by proxy. In some embodiments, for example where the virtual world 132 comprises mixed reality, the position and movement of the avatar's head, hands, and/or feet may be mapped to the position and movement of the user's respective head, hands, and/or feet based on data from sensors including sensors embedded in mixed reality devices, such that the position and movement of the avatar correspond to the real-world position and movement of the user. The user may interact with virtual objects and the virtual environment within the virtual world 132 through the avatar.

In embodiments, the virtual world 132 may be stored and/or hosted locally, for example on a client computing device such as computer 101 or end user device 103. In embodiments, the virtual world 132 may be stored and/or hosted remotely, such as on remote server 104. The virtual world 132 may be stored and/or hosted on any number or combination of devices including computer 101, end user device 103, remote server 104, private cloud 106, and/or public cloud 105, peripheral device set 114, and/or on any other device connected to WAN 102. Furthermore, the virtual world 132 may be distributed in its operation or storage over any number or combination of the aforementioned devices.

According to the present embodiment, the virtual world program 107 may be a software program capable of creating, running, and maintaining one or more virtual worlds 132. The virtual world program 107 continuously updates and maintains the state of the virtual world 132, ensuring that any changes made by users or system events are saved and reflected accurately in future sessions. The virtual world program 107 executes the core logic of the virtual world 132, including the physics, AI, collision detection, and rule enforcement. The virtual world program 107 handles all real-time communication between users and the virtual world 132, for example using protocols like TCP/IP or UDP. In embodiments of the invention, the virtual world program 107 may be equipped with an application programming interface (API) that facilitates interfacing with the aggregate world program 108, enabling virtual world program 107 and aggregate world program 108 to quickly and securely exchange information regarding sub-worlds extracted by the aggregate world program 108, movements and interactions of users, world mappings, et cetera. In embodiments of the invention, the virtual world program 107 may be stored and/or run within or by any number or combination of devices including computer 101, end user device 103, remote server 104, private cloud 106, and/or public cloud 105, peripheral device set 114, and/or on any other device connected to WAN 102. Furthermore, virtual world program 107 may be distributed in its operation over any number or combination of the aforementioned devices. For example, in some embodiments, the virtual world program 107 may be entirely stored and/or run on a remote server 104. In some embodiments, the virtual world program 107 may comprise both client-side and server-side components, and may be distributed in its operation between both a client computing device such as a computer 101 or end user device 103, as well as a server device such as remote server 104. In some embodiments, the virtual world program 107 may be entirely client-side, and may be stored and/or run on a client computing device such as computer 101 or end user device 103.

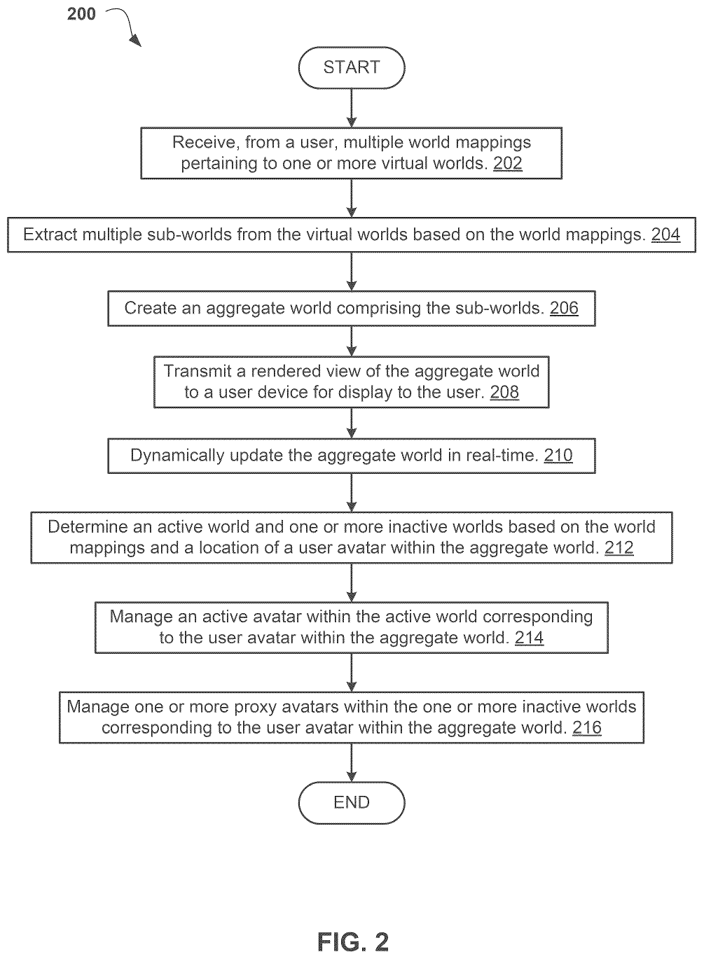

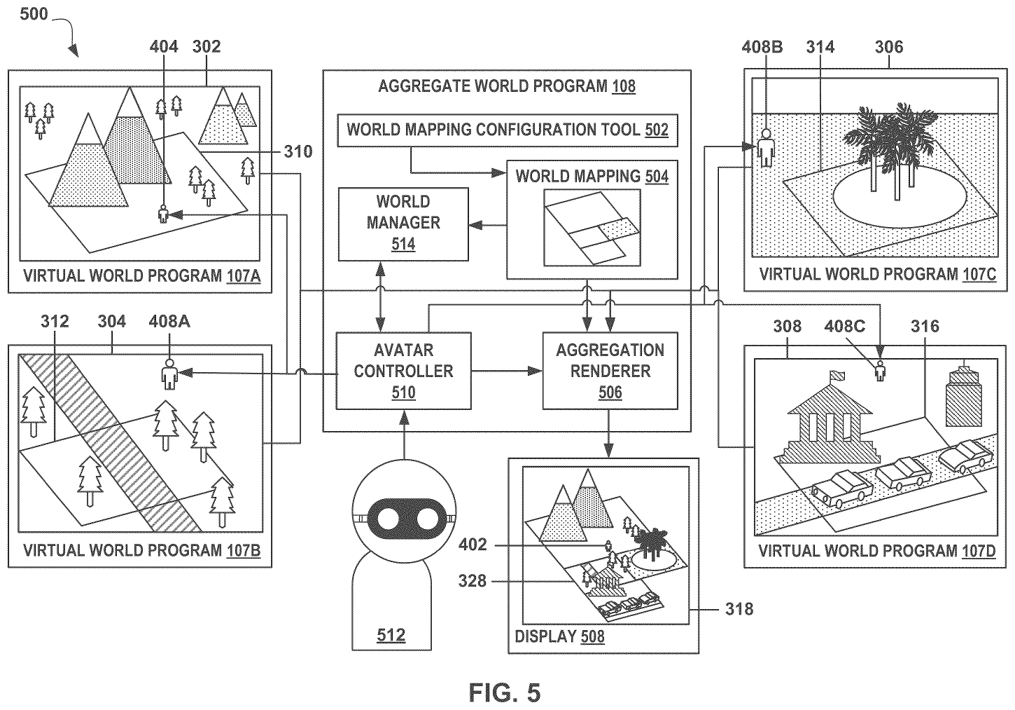

According to the present embodiment, the aggregate world program 108 may be a program enabled to extract portions of one or more virtual worlds, and combine the extracted portions, or sub-worlds, into a single aggregate virtual world. The aggregate world program 108 may, when executed, cause the computing environment 100 to carry out an aggregate world process 200. The aggregate world process 200 may be explained in further detail below with respect to FIG. 2 and FIG. 5. In embodiments of the invention, the aggregate world program 108 may be stored and/or run within or by any number or combination of devices including computer 101, end user device 103, remote server 104, private cloud 106, and/or public cloud 105, peripheral device set 114, and/or on any other device connected to WAN 102. Furthermore, aggregate world program 108 may be distributed in its operation over any number or combination of the aforementioned devices. The aggregate world program 108 may be integrated into, a component of, a functionality or subroutine of, or otherwise in communication with one or more virtual world programs 107.

Referring now to FIG. 2, an operational flowchart illustrating an aggregate world process 200 is depicted according to at least one embodiment. At 202, the aggregate world program 108 may receive, from a user, multiple world mappings pertaining to one or more virtual worlds 132. The world mapping may be a data structure comprising information describing a region, or sub-world, within a virtual world 132 that the user wishes to extract and add to an aggregate world; this information may include the virtual world 132 where the sub-world is located, size and dimensions of the sub-world, and the location of the sub-world within its virtual world 132. In embodiments, the world mappings may pertain to multiple regions within the same virtual world 132; world mappings may even overlap. In embodiments, the world mappings may describe nested sub-worlds, where a world contains a sub-world of a world that also as a sub-world from it. In embodiments, each time the space of a virtual world 132 to be added to an aggregate world is specified, a new URL is generated. In embodiments, the aggregate world program 108 may comprise a world mapping configuration tool, through which a user may create a world mapping. The world mapping tool may be a tool to manage the arrangement of multiple subworlds into a custom world. It contains information about size, placement of the subworlds and relative position of avatars.

In embodiments, the world mapping may comprise a URL that specifies an area of the user's desired size within a virtual world 132; the URL is used to represent the area captured by the subworld, and may be used as an API endpoint for the servers hosting the virtual world 132 and the aggregate world to communicate with each other, to communicate the state of the avatars, changes to the worlds, et cetera. The aggregate world program 108 may also bring items between a virtual world 132 and the aggregate world using the API. In embodiments, the system may comprise a central server to host items or locations present in multiple worlds, so that the latest status of such items or locations can be updated by any world when the user is using it.

At 204, the aggregate world program 108 may extract multiple sub-worlds from the virtual worlds based on the world mappings. Here, the aggregate world program 108 may consult each world mapping, determines the location, size, dimensions, and orientation, and extracts a region of the specified size, dimensions, and orientation from the specified virtual world 132 at the specified location. The aggregate world program 108 extracts the sub-world by identifying the virtual world 132 where the sub-world is located, and transmitting the world mapping to the virtual world program 107, which transmits back the data describing the sub-region specified in the world mapping. In embodiments, the subworld extraction is performed not by rendering the mapped section of the virtual world 132 locally within the aggregate world, but rather on the original virtual world 132's servers; the view area of the user avatar within the aggregate world is sent to the original virtual world 132 to obtain a rendered view of each of the virtual world 132 and that information is then combined in the aggregate world to be re-rendered and combined locally.

At 206, the aggregate world program 108 may create an aggregate world comprising the sub-worlds. Here, the aggregate world program 108 combines multiple sub-worlds into one geographically contiguous virtual world, by placing the sub-regions adjacent to each other within a customized virtual space. Adjacent sub-worlds may be fused to enable a user avatar to seamlessly walk between sub-regions. The user may specify the positioning of the sub-worlds in the world mapping relative to each other or to an existing arrangement, or the aggregate world program 108 may arrange the sub-worlds automatically. In embodiments, the sub-worlds may be restricted to rectangular shapes, and may be restricted to particular sizes, so that the aggregate world program 108 may cleanly fit the sub-worlds together. After the aggregate world has been created, the aggregate world program 108 may continue to add new sub-worlds to the aggregate world as new world mappings are received from a user. In embodiments, the aggregate world program 108 may store a layout of the aggregate world, which may be a skeleton that represents the size, positioning, and relative arrangement of the sub-worlds; the aggregate world program 108 may not model or simulate the sub-worlds until a user logs into the customized virtual space, and/or when a user avatar comes within a predetermined threshold distance of where a sub-world would be positioned in the aggregate world, at which point the aggregate world program 108 may load in and render the sub-world by retrieving the sub-world from its corresponding virtual world 132.

In embodiments, the aggregate world may aggregate all of the pre-rendered views from each of the virtual worlds 132 for each of the avatars within the aggregate world and re-render the views locally to combine them locally, hiding any overlapping areas to make the aggregate world appear seamless. For example, if an object from one virtual world 132 obscures the view of another virtual world 132, then the aggregate world program 108 may make sure that the aggregation is seamless and natural looking when the object and virtual world 132 are combined by appropriately occluding, from the view of the user, the sections of the virtual world 132 hidden behind the object. In embodiments, if the view of an avatar within the aggregate world is of the boundaries of the subworlds, then the aggregate world program 108 can use, for example, a rendering method which requests the 3D models of the virtual worlds 132 and renders them locally. The aggregate world program 108 requests the 3D boundary information (subworld geometry descriptor) from the virtual world program 107 and the received information is used when creating the aggregate world with prerendered views of each of the virtual worlds 132 for each of the avatars. In another example, the aggregate world program 108 may obtain all the 3D objects comprising the virtual worlds 132 already prerendered, but then reposition all the objects from all of the virtual worlds 132 and combine them based on their location, then rendering them later. The aggregate world program 108 may use a combination of these methods to achieve a seamless experience for the user.

The customized virtual space comprising the aggregate world may be a world much like the virtual worlds 132 from which the aggregate world is built; a computer-simulated virtual space. The customized virtual space may host only the user, may incorporate participants from parent worlds that are within sub-worlds comprising the aggregate world, and/or may enable additional participants to log in locally. The participants may interface with the aggregate world through a user interface device, which may comprise UI device set 123 and may include such devices as mice, keyboards, microphones, touchpads, et cetera. In embodiments, the aggregate world program 108 may retrieve the physics, or set of rules, that govern the parent worlds, and apply the physics to the sub-worlds that correspond with the physics of their parent worlds, such that a user avatar crossing the boundary into a sub-world will become subjected to the same physics that govern the parent world of that sub-world.

In embodiments, the customized virtual space may be a mixed-reality virtual space, which may include augmented reality environments wherein generated images, sounds, haptic feedback, and other sensations are integrated into a real-world environment to create a hybrid augmented reality environment, comprising both virtual and real-world elements. The mixed reality customized virtual space may include virtual reality environments which fully replace the physical environment with virtual elements, such that a user experiencing a virtual reality environment cannot see any objects or elements of the physical world; in such embodiments, the user interface device may comprise a mixed reality device, which may be any device or combination of devices enabled to record real-world information that the aggregate world program 108 may overlay with computer-generated perceptual elements to create the mixed-reality customized virtual space; the mixed reality device may further record the actions, position, movements, et cetera of the user, to track the user's movement within and interactions with the mixed reality environment. The mixed reality device may display the mixed reality environment to the user. The mixed reality device may be equipped with or comprise a number of sensors such as a camera, microphone, accelerometer, et cetera, and these sensors and/or may be equipped with or comprise a number of user interface devices such as displays, touchscreens, speakers, et cetera. In some embodiments, the mixed reality device may be a headset that is worn by the viewer.

At 208, the aggregate world program 108 may transmit a rendered view of the aggregate world to a user device for display to the user. The aggregate world program 108 may generate a rendered view of the aggregate world, which may be a view of the aggregate world from the perspective of the user avatar; in other words, the rendered view is the view of the aggregate world that the user avatar is seeing at any given moment. The aggregate world program 108 may model a cone of vision of the user avatar, based on, for example, user-selected graphical settings such as field-of-view preferences which determine the cone's width, the render distance which determines the cone's length, et cetera, as well as the location, position, and orientation of the “eyes” on the user avatar, which may be the point or points on the user avatar from which the cone of vision representing the avatar's vision emanates; the “eyes” of the user avatar may be pre-provided to the aggregate world program 108. Once the aggregate world program 108 has identified the cone of vision of the user avatar, the aggregate world program 108 may generate the rendered view by rendering all of the aggregate world that falls within the cone of vision, and transmitting this view to the user device for display to the user. The rendered view allows the user to “see through the eyes” of the user avatar, and observe the aggregate world. In embodiments, the view may be rendered remotely by the virtual world program 107 and then provided to the aggregate world program 108 pre-rendered as a video stream or collection of images to be combined. Then the aggregate world program 108 can use its resources to combine multiple pre-rendered videos into an aggregate view of all of the virtual worlds 132 that were received as a collection of video streams.

At 210, the aggregate world program 108 may dynamically update the aggregate world in real-time. Here, the aggregate world program 108 may request, and may receive, regular and/or real-time information regarding each sub-world comprising the aggregate world from the virtual world program or programs 107 hosting the virtual worlds that the sub-worlds were extracted from. The aggregate world program 108 may continually update each sub-world comprising the aggregate world with the latest information as the information is received, such that each sub-world comprising the aggregate world mimics the state of the corresponding sub-world in the virtual world 132 from which it was originally extracted; in other words, all changes made to the sub-worlds within the virtual world 132, by avatars of other users or admins, world events, et cetera, are saved and incorporated into the corresponding sub-world in the aggregate world. In embodiments, the aggregate world program 108 may communicate changes made to a sub-world in the aggregate world by the user avatar or entities, processes, admins, et cetera within the aggregate world to the virtual world program or programs 107 hosting the virtual worlds 132 that the sub-worlds were extracted from.

In embodiments, the aggregate world program 108 may update the aggregate world in real time with the avatars of all participants within the parent worlds, or, in embodiments, with the avatars of all participants in the active world. The aggregate world program 108 may dynamically retrieve the locations, appearance, behaviors, and all other such qualities of participant avatars from the virtual world program or programs 107 of the parent worlds, and may graphically represent all active participants within the aggregate world.

At 212, the aggregate world program 108 may determine an active world and one or more inactive worlds based on the world mappings and a location of a user avatar within the aggregate world. Here, the aggregate world program 108 may compare a location of the user avatar with the layout of the aggregate world; the aggregate world program 108 may determine that the virtual world 132 with a sub-world corresponding to the sub-world that the user avatar is currently located within is the “active world,” and all other virtual worlds 132 with sub-worlds corresponding with sub-worlds within the aggregate world are “inactive worlds.” The aggregate world program 108 may repeat the active world determination at regular intervals so as to dynamically identify when the user avatar has crossed from one sub-world to another, and to change the virtual world 132 associated with the new sub-world to the “active world” and the virtual world 132 associated with the previous active world to an “inactive world.”

At 214, the aggregate world program 108 may manage an active avatar within the active world corresponding to the user avatar within the aggregate world. When the user avatar in the aggregate world is within a sub-world, the aggregate world program 108 may represent the user avatar in the active world corresponding to that sub-world via an active avatar; the aggregate world program 108 may dynamically communicate all user inputs entered to control the user avatar to the virtual world program 107 hosting the active world, such that the active avatar may look, act, and behave in exactly the same way as the user avatar. Furthermore, the aggregate world program 108 may enable participants in the active world to interact and/or communicate with the active avatar as if they were interacting with and/or communicating with the user avatar, for example by transmitting messages received in the active world to the user's computer 101 or end user device 103.

In embodiments of the invention, when an active world becomes inactive, for example when the user avatar has left the sub-world by walking out of the sub-world's boundaries in the aggregate world, the active avatar may disappear from the active world as the active world becomes inactive; users in the active world may see the active avatar fade from view. In the virtual world 132 that the user avatar has just entered, users may see the active avatar materialize as the virtual world 132 becomes the active world, at the location within the active world corresponding to the location in the sub-world where the user avatar entered the sub-world.

At 216, the aggregate world program 108 may manage one or more proxy avatars within the one or more inactive worlds corresponding to the user avatar within the aggregate world. In embodiments, the active avatar may not disappear when it leaves the active world; instead, the active avatar may be replaced by a proxy avatar; the proxy avatar may be a placeholder, a still object or a static representation of the active avatar, which may visually indicate that the avatar is in a paused state. The proxy avatar may receive only inputs corresponding to the current location of the user avatar, such that the proxy avatar mirrors the user avatar's location within the aggregated world, but does not mirror the user avatar's behavior. Users in the inactive world where the proxy avatar is currently operating may address and/or otherwise communicate with the proxy avatar, and the aggregate world program 108 may convey these communications to the user.

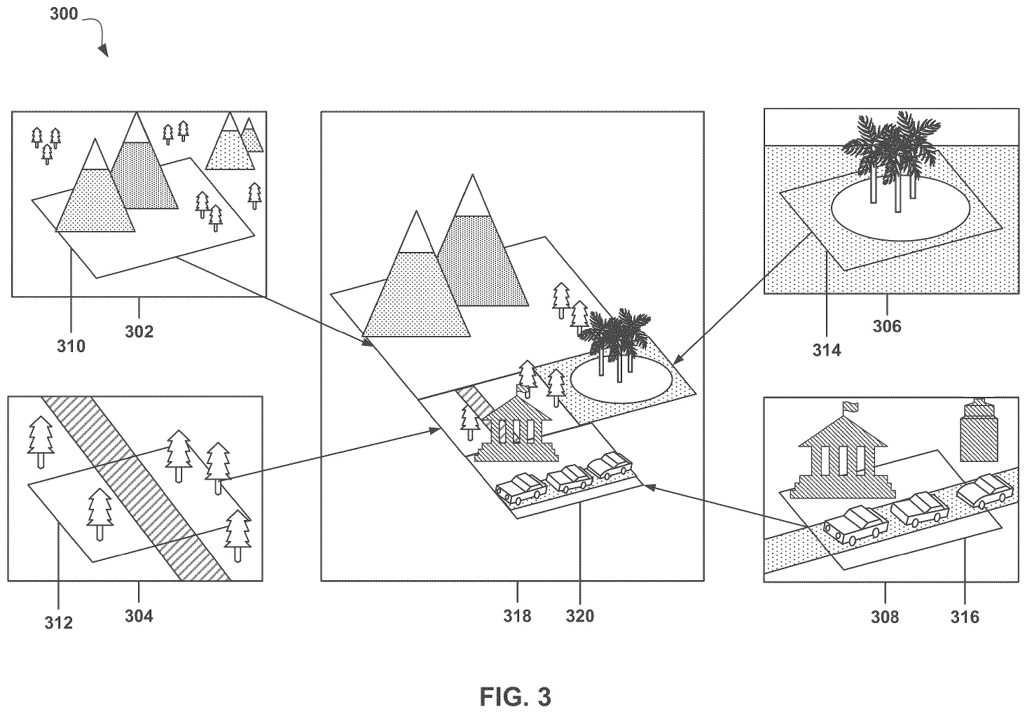

Referring now to FIG. 3, an exemplary world mapping process 300 comprising the aggregate world process 200 is depicted according to at least one embodiment. Here, the aggregate world program 108 has received world mappings from a user pertaining to four virtual worlds 132: an alpine virtual world 302, a forested virtual world 304, a tropical island virtual world 306, and a racetrack virtual world 308. The world mapping for the alpine virtual world 302 comprises the alpine sub-world 310, the world mapping for the forested virtual world 304 comprises the forested sub-world 312, the world mapping for the tropical island virtual world 306 comprises the tropical island sub-world 314, and the world mapping for the racetrack virtual world 308 comprises the racetrack sub-world 316. The aggregate world program 108 instantiates a customized virtual space 318, which is initially empty, and extracts the alpine sub-world 310, the forested sub-world 312, the tropical island sub-world 314, and the racetrack sub-world 316. The aggregate world program 108 places the extracted sub-worlds within the customized virtual space 318 to create an aggregate world 320.

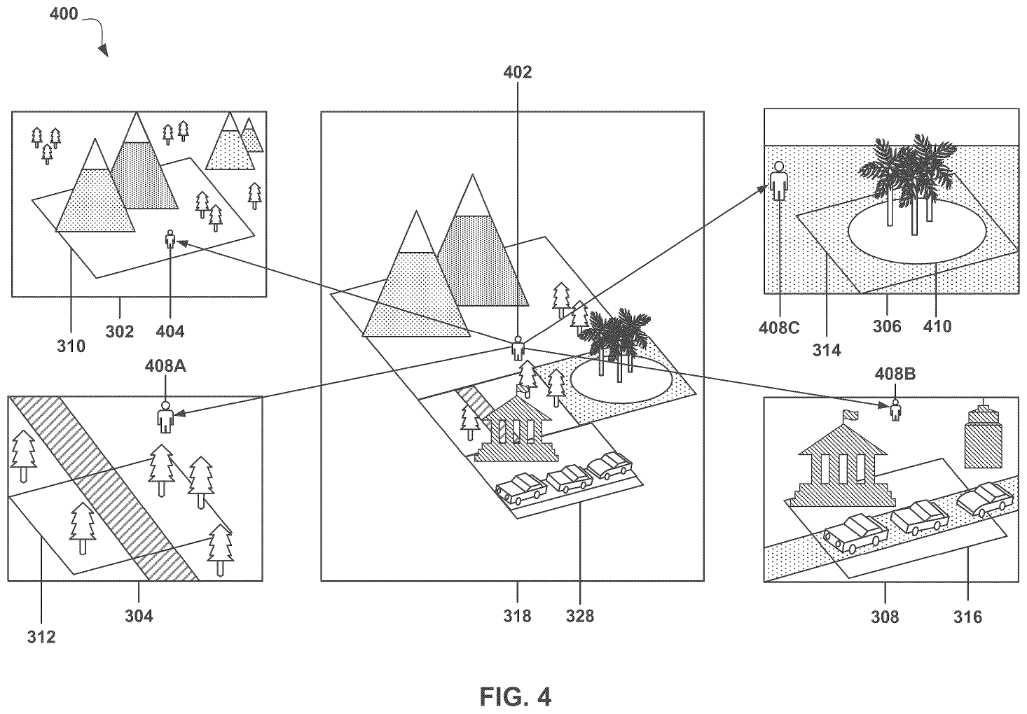

Referring now to FIG. 4, an exemplary avatar management process 400 comprising the aggregate world process 200 is depicted, according to at least one embodiment. Here, a user is controlling a user avatar 402 to explore an aggregate world 320 within a customized virtual space 318. The aggregate world 320 comprises four sub-worlds combined into one; an alpine sub-world 310 extracted from an alpine virtual world 302, a forested sub-world 312 extracted from a forested virtual world 304, a tropical island sub-world 314 extracted from a tropical island virtual world 306, and a racetrack sub-world 316 extracted from a racetrack virtual world 308. Here, the aggregate world program 108 identifies that the user avatar 402 is located within the portion of the aggregate world 320 corresponding to the alpine sub-world 310; the aggregate world program 108 accordingly determines that the alpine virtual world 302 is the active world, and that the forested virtual world 304, the tropical island virtual world 306, and the racetrack virtual world 308 are inactive worlds. The aggregate world program 108 manages avatars in each of the four virtual worlds 132; the avatar in the active world, here alpine virtual world 302, is the active avatar 404. The avatar in the inactive worlds, here the forested virtual world 304, the tropical island virtual world 306, and the racetrack virtual world 308, are proxy avatars 408A, 408B, and 408C, respectively. The active avatar 404 is identical in appearance and behavior to the user avatar 403; the aggregate world program 108 transmits all inputs and data corresponding to the user avatar 402 in real time to the virtual world program 107 hosting the alpine virtual world 302, such that the active avatar 404 occupies the same relative position in the alpine virtual world 302 as the user avatar 402, and moves and interacts in the same way. The proxy avatars 408A, 408B, and 408C are here only maintained as placeholders; the aggregate world program 108 only transmits the location of the user avatar 402 to the virtual world program or programs 107 that are hosting the inactive worlds, such that only a simple visual marker is present at a location in the inactive worlds that corresponds to the user avatar's 402 location in the aggregate world 320 relative to the sub-world associated with the inactive world. For example, the user avatar 402 is standing in a portion of the aggregate world 320 that corresponds to the alpine sub-world 310; the user avatar 402 is located west of the island 410 comprising the portion of aggregate world 320 that corresponds with tropical island sub-world 314. Accordingly, the user avatar 402 is represented in the tropical island virtual world 306 as a proxy avatar 408C that is located in the same place as the user avatar 402 relative to the island 410, which here is above an ocean.

FIG. 5 is a component diagram illustrating an exemplary embodiment of a system 500 implementing an aggregate world process 200, according to at least one embodiment. Here, the aggregate world program 108 comprises a world mapping configuration tool 502, which is a software tool that allows a user to create world mapping 504. Here, the user has interacted with the world mapping configuration tool 502 to create a world mapping 504 comprising each of four virtual worlds 132: an alpine virtual world 302, a forested virtual world 304, a tropical island virtual world 306, and a racetrack virtual world 308, hosted on virtual world program 107A, virtual world program 107B, virtual world program 107C, and virtual world program 107D, respectively. The world mapping 504 for the alpine virtual world 302 comprises the alpine sub-world 310, the world mapping 504 for the forested virtual world 304 comprises the forested sub-world 312, the world mapping 504 for the tropical island virtual world 306 comprises the tropical island sub-world 314, and the world mapping 504 for the racetrack virtual world 308 comprises the racetrack sub-world 316.

The world mapping 504 is passed to the aggregation renderer 506, which uses the world mapping 504 to locate and extract the alpine sub-world 310, the forested sub-world 312, the tropical island sub-world 314, and the racetrack sub-world 316, combining them into an aggregate world 320 within a customized virtual space 318. The aggregation renderer 506 generates a view of the aggregate world 320 from the perspective of the user avatar 402, and passes the aggregate world 320 to display 508, to be displayed to a user.

The aggregate world program 108 comprises an avatar controller 510, which receives inputs from a user interface device 512 which comprises UI device set 123. The avatar controller 510 applies the user inputs to a user avatar 402, and identifies the location of the user avatar 402 within the aggregate world 318. The avatar controller 510 regularly communicates the location of the user avatar 402 to the world manager 514; the world manager 514 checks the location of the user avatar 402 against the world mapping 504 to determine which of the sub-worlds comprising the aggregate world 320 the user avatar 402 is currently located in; the world manager 514 identifies that sub-world as the active sub-world. Here, the user avatar 402 is currently located within the region of the aggregate world 320 that corresponds to the alpine sub-world 310; the world manager 514 accordingly determines that the alpine virtual world 302 is the active world and the forested virtual world 304, the tropical island virtual world 306, and the racetrack virtual world 308 are inactive worlds, and transmits this information back to the avatar controller 510.

The avatar controller 510 accordingly determines that the avatar in the alpine virtual world 302 is the active avatar 404, and the avatars in forested virtual world 304, tropical island virtual world 306, and racetrack virtual world 308 are proxy avatars 408A, 408B, and 408C, respectively. Avatar controller 510 continually and dynamically transmits the user inputs from user device 516 to virtual world program 107A so that they may be applied to the active avatar 404, and continually and dynamically transmits the location of the user avatar 402 to virtual world program 107B, virtual world program 107C, and virtual world program 107D so it may be applied to the proxy avatars 408A, 408B, and 408C, respectively. The avatar controller 510 may dynamically communicate the location and behaviors of the user avatar 402 to the aggregation renderer 506 in real time, so that the aggregation renderer 506 may accurately generate a view of the aggregate world 320 from the perspective of the user avatar 402 to pass to the display 508 for display to the user.

It may be appreciated that FIGS. 2-5 provide only illustrations of individual implementations and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for aggregating multiple virtual worlds, the method comprising:
receiving, from a world mapping tool, a plurality of world mappings pertaining to one or more virtual worlds;
extracting multiple sub-worlds from the one or more virtual worlds based on the plurality of world mappings;
creating an aggregate world comprising the multiple sub-worlds; and
transmitting a rendered view of the aggregate world to a user device for display to the user.

2. The method of claim 1, further comprising:
dynamically updating the aggregate world in real time.

3. The method of claim 1, further comprising:
determining an active world and one or more inactive worlds based on the world mappings and a location of a user avatar within the aggregate world.

4. The method of claim 3, further comprising:
managing an active avatar within the active world corresponding to the user avatar within the aggregate world.

5. The method of claim 3, further comprising:
managing one or more proxy avatars within the one or more inactive worlds corresponding to the user avatar within the aggregate world.

6. The method of claim 1, wherein each sub-world comprising the aggregate world is subject to separate physics.

7. The method of claim 1, wherein the aggregate world comprises a mixed-reality world.

8. A computer system for aggregating multiple virtual worlds, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving, from a world mapping tool, a plurality of world mappings pertaining to one or more virtual worlds;
extracting multiple sub-worlds from the one or more virtual worlds based on the plurality of world mappings;
creating an aggregate world comprising the multiple sub-worlds; and
transmitting a rendered view of the aggregate world to a user device for display to the user.

9. The computer system of claim 8, further comprising:
dynamically updating the aggregate world in real time.

10. The computer system of claim 8, further comprising:
determining an active world and one or more inactive worlds based on the world mappings and a location of a user avatar within the aggregate world.

11. The computer system of claim 10, further comprising:
managing an active avatar within the active world corresponding to the user avatar within the aggregate world.

12. The computer system of claim 10, further comprising:
managing one or more proxy avatars within the one or more inactive worlds corresponding to the user avatar within the aggregate world.

13. The computer system of claim 8, wherein each sub-world comprising the aggregate world is subject to separate physics.

14. The computer system of claim 8, wherein the aggregate world comprises a mixed-reality world.

15. A computer program product for aggregating multiple virtual worlds, the computer program product comprising:
one or more computer-readable tangible storage medium and program instructions stored on at least one of the one or more tangible storage medium, the program instructions executable by a processor to cause the processor to perform a method comprising:
receiving, from a world mapping tool, a plurality of world mappings pertaining to one or more virtual worlds;
extracting multiple sub-worlds from the one or more virtual worlds based on the plurality of world mappings;
creating an aggregate world comprising the multiple sub-worlds; and
transmitting a rendered view of the aggregate world to a user device for display to the user.

16. The computer program product of claim 15, further comprising:
dynamically updating the aggregate world in real time.

17. The computer program product of claim 15, further comprising:
determining an active world and one or more inactive worlds based on the world mappings and a location of a user avatar within the aggregate world.

18. The computer program product of claim 17, further comprising:
managing an active avatar within the active world corresponding to the user avatar within the aggregate world.

19. The computer program product of claim 17, further comprising:
managing one or more proxy avatars within the one or more inactive worlds corresponding to the user avatar within the aggregate world.

20. The computer program product of claim 15, wherein each sub-world comprising the aggregate world is subject to separate physics.
